(19) United States
(12) Patent Application Publication
(10) Pub. No.: US 2025/0336555 A1
(43) Pub. Date: Oct. 30, 2025

(54) RADIATION SHIELDING GARMENT

(71) Applicant: Lazar Lazarovski, Goodlettsville, TN (US)

(72) Inventor: Lazar Lazarovski, Goodlettsville, TN (US)

(21) Appl. No.: 19/192,068

(22) Filed: Apr. 28, 2025

Related U.S. Application Data
(60) Provisional application No. 63/639,634, filed on Apr. 27, 2024.

(51) Int. Cl. G21F 3/02; G21F 1/12

(52) U.S. Cl. CPC G21F 3/02; G21F 1/12

(57) ABSTRACT

The radiation shielding garment can protect users from long term exposure to cosmic radiation and prevent the development of cancer or diseases. A radiation shielding garment can have multiple layers including a first fabric outer layer, a second fabric outer layer, at least one radiation shielding layer, and an inner fabric layer. The radiation shielding layer contains antimony or a lead equivalent, and a water-resistant material. The radiation shielding layer is also perforated, enabling the radiation shielding garment to be breathable and worn for long periods of time. The outer and inner fabric layers are made from lightweight materials, which can be adapted into uniforms commonly worn by pilots and flight attendants.

### CROSS REFERENCE TO RELATED APPLICATIONS

This application claims the benefit of the U.S. Utility Application No. U.S. 63/639,634 filed on Apr. 27, 2024, which is incorporated herein in its entirety. The teaching of the radiation shielding garment of the above application is incorporated herein by reference.

### FIELD OF THE INVENTION

Embodiments of the present disclosure relate to the field of radiation shielding apparel, and more specifically, to radiation shielding apparel that is functional and can easily be worn by a user.

### BACKGROUND OF THE INVENTION

Protection from long-term cosmic radiation is very important to prevent cancer or other diseases. For example, travelers, especially those who fly frequently, are exposed to cosmic forms of ionizing radiation at high altitudes during airplane travel. In fact, the aviation industry has recognized the need for enhanced radiation protection for airline pilots and flight attendants due to their prolonged exposure to cosmic radiation at high altitudes. This cosmic radiation consists of high-energy particles from space. Long-term exposure to this form of radiation can lead to various adverse health effects, including an increased risk of sickness or disease, such as, but not limited to, cancer. The general public and flight crews such as pilots and flight attendants, all are in need or protection from cosmic radiation during flights in airplanes. Reports show that airline pilots fly up to 900 hours per year and have an increased risk of cancer. Up to 5× more likely to develop cancer than the general public, while female flight attendants are 2× more likely to develop breast cancer.

Traditional radiation protection solutions are often bulky, heavy, and not designed for comfort or long wear periods, making them unsuitable for the dynamic and customer-facing environment of airline operations. An example of a traditional radiation shielding apparatus is a lead apron that is typically worn during the taking of x-rays at a dentist office. The lead apron is made of a thin rubber material on the outside and a lead center material on the inside. While the patient is wearing the apron during the undergoing of dental X-rays, their bodies and organs have protection. Unfortunately, a lead apron is heavy, uncomfortable, and not visually appealing. Therefore, a better solution for providing radiation shielding is needed. In addition, recognizing the potential health risks associated with cosmic radiation exposure during flight, there is a need for protective apparel that can mitigate these risks effectively.

### SUMMARY OF THE INVENTION

Embodiments of the present invention provide a radiation shielding garment that can be worn by individuals during flight to protect against cosmic radiation. One example of such a garment, which is described within the present disclosure, is a vest that may be worn by travelers during flight. The vest can incorporate multiple layers and can contain a lining made of materials with antimony and/or lead equivalency in shielding capability, which are known for their radiation attenuation properties. The lining is strategically placed to shield vital organs and sensitive body tissues from radiation.

In accordance with a first embodiment, the garment contains a first fabric outer layer, a radiation shielding layer containing antimony and/or a lead equivalency, or a mixture of this equivalency, and a second fabric outer layer. The fabric outer layers may be, for example, but not limited to, cotton layers that encapsulate the radiation shielding layer. The radiation shielding layer containing antimony and/or a lead equivalency or a mixture of this equivalency, is perforated to allow for breathability of the center core layer. According to this embodiment, the perforations may be approximately 260 micrometers in diameter, thereby maintaining maximum protection while ensuring comfort through flexibility and breathability.

In accordance with another aspect of this embodiment of the invention, two radiation shielding layers can provided, and the two radiation shielding layers are separated by an inner fabric layer. Therefore, this aspect of the invention contains a first fabric outer layer, a first radiation shielding layer containing antimony and/or a lead equivalency, or a mixture of this equivalency, an inner fabric layer, a second radiation shielding layer containing antimony and/or a lead equivalency, or a mixture of this equivalency, and a second fabric outer layer. The holes of the first and second radiation shielding layers do not align, therefore, the holes can be larger while maintaining a shield for the organs of a user.

In accordance with another embodiment of the invention, antimony is blended with fabric to create protective clothing items, including pants, vests, shirts, hats, and medical scrubs, aimed at shielding wearers from radiation. No layers are needed for radiation shielding.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in ever drawing. In the drawings:

FIG. 1 shows the layers of the radiation shielding garment, as a vest, including the first and second outer layers, first and second radiation shielding layers, and an inner fabric layers.

FIG. 2 shows the layers of the radiation shielding garment, including a blend of antimony with raincoat fabrics in a pullover or pant form.

FIG. 3 shows antimony as a spun fabric used to create street wear clothing, or medical clothing.

### DETAILED DESCRIPTION OF THE INVENTION

The present invention provides a radiation shielding garment. For exemplary purposes an embodiment of a radiation shielding vest is described, however, one having ordinary skill in the art will appreciate that the radiation shielding garment is not limited to the shape of a vest and other types of garments may be provided, such as, but not limited to, a shirt, jacket, overcoat, pants, or other garment.

The radiation shielding vest is constructed to offer both protection and comfort. When worn by a traveler, the vest's antimony, and/or lead equivalency or mixture thereof, lining acts to attenuate cosmic radiation, thereby reducing the wearer's exposure to harmful radiation. The traveler puts the vest on in the traditional way with a zipper or buttons being the front part of the vest. Of course, the vest may instead be a pullover vest without a zipper or buttons. This protective measure is particularly beneficial for frequent flyers and flight crew members who are regularly exposed to elevated levels of cosmic radiation, although use is not limited to such individuals.

The present invention offers effective radiation protection while ensuring comfort, flexibility, and style for airline crew members and others. The clothing line integrates the antimony with advanced materials/fabrics to create a lightweight and radiation-protective garment. The garment can be water-resistant. The present radiation shielding garment is intended to replace or complement current uniforms of airline pilots and flight attendants, providing a practical solution to reduce their exposure to cosmic radiation. Such radiation shielding garments can even be offered to travelers for use during flying or sold commercially.

The antimony and/or lead equivalency inner core material is selected for its superior ability to attenuate harmful radiation effectively while also being very light in comparison to lead. Antimony is known for its high atomic number and low conductivity, offering excellent radiation shielding properties. Vital organs are most sensitive to radiation exposure, and the use of antimony in a vest or other clothing garment significantly reduces a wearer's exposure to potential health risk. The inclusion of cotton between the antimony layers serves to enhance the comfort of the wearer, making the vest suitable for flights that are long in duration (3+ hours).

It is noted that a different element may be selected instead of antimony, as long as the substitute element similarly contains the radiation blocking capability of antimony. By combining effective radiation shielding materials with a design focused on comfort, mobility, and even style, this invention addresses the critical need for protection against cosmic radiation exposure during airplane travel, enhancing the safety and well-being of all travelers, especially those who fly frequently.

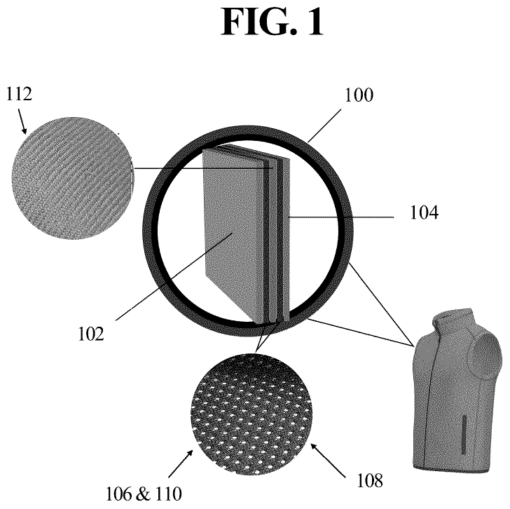

FIG. 1 is a schematic diagram illustrating an example of a radiation shielding garment 100 as a vest, in accordance with the present invention. The illustration also shows layers of the vest. In accordance with the first exemplary embodiment of the invention, the vest contains a first outer layer 102 and a second outer layer 104. The first and second outer layers may be made of different categories of material based on how the radiation shielding garment is to look and feel. For instance, the first outer layer 102, which would be on the outside of the garment, could be cotton, nylon, or any material as this layer is not intended to provide the radiation shielding capability of the radiation shielding garment. Instead, the first outer layer 102 is intended to provide the look and feel of the garment. The second outer layer 104 would be positioned closest to the body of the garment wearer when the radiation shielding garment is worn. The second outer layer 104 may be an inner lining made from soft, skin-friendly materials such as fleece or cotton, which provides additional comfort for the wearer, making the garment suitable for long flights.

According to this embodiment, the first radiation shielding layer 106 is provided within the radiation shielding garment 100. The first radiation shielding layer 106 is intended to shield the wearer of the garment from radiation. The primary material of the first radiation shielding layer 106 may be, for example, but not limited to, high-quality, durable raincoat fabrics known for their water resistance and breathability. Examples may include, but are not limited to, polyester, polyurethane, and/or Gore-Tex. Antimony is incorporated into the fabric through a process described hereafter, which disperses antimony particles evenly throughout the material of the first radiation shielding layer 106, ensuring comprehensive radiation protection without compromising the fabric's flexibility and wearability. The process of incorporation includes dispersing antimony particles evenly throughout the material, ensuring comprehensive radiation protection without compromising the fabric's flexibility, breathability, wearability, and even, if desired, water resistance. This is accomplished by blending, for example, 35% antimony, 25% polyester, 15% nylon, 15% polyethylene, and 10% elastane, respectively, so that the fabric as a whole offers equal protection to each area of the body it covers. It is noted that the method of fabrication of the first radiation shielding layer is not intended to be limited to this described process. Different degrees of radiation shielding may be provided by use of different percentages of components used in the blending.

According to this embodiment, the first radiation shielding layer 106 can be perforated, containing an array of holes 108 for providing breathability to the first radiation shielding layer 106, and therefore, to the entire radiation shielding garment 100. A diameter of the breathability holes may be, but is not limited to, 260 micrometers. It is noted that the present invention is not limited to having breathability holes that are exactly 260 micrometers. Instead, these measurements are provided for exemplary purposes and one having ordinary skill in the art would know a range of hole diameters that would allow for breathability, while providing radiation shielding properties at the level desired by the radiation shielding garment 100.

According to this embodiment, an inner fabric layer 112 can be provided central to the first radiation shielding layer 106 and a second radiation shielding layer 110 of the radiation shielding garment 100. The inner fabric layer 112 may be an easy to move material such as, but not limited to, cotton. The inner fabric layer 112 does not need to provide radiation shielding capability, although it could.

According to this embodiment, the second radiation shielding layer 110 can be positioned between the inner fabric layer 112 and the second outer layer 104. Like the first radiation shielding layer, the second radiation shielding layer 110 contains an array of holes 108 for providing breathability to the entire radiation shielding garment 100. A diameter of the holes 108 may be, but is not limited to, 260 micrometers. The present invention is not limited to having holes 108 that are exactly 260 micrometers. Instead, these measurements are provided for exemplary purposes and one having ordinary skill in the art would know a range of hole diameters that would allow for breathability, while providing radiation shielding properties.

The first and second radiation shielding layers can be composed of the same material or different material. In addition, the process of making the first and second radiation shielding layers can be the same or different. The diameter of the first and second radiation shielding layers holes 108 are selected with knowledge that the first and second radiation shielding layers are separated by the inner fabric layer 112, and that the holes 108 of the first and second radiation shielding layers will not perfectly align when a user wears the radiation shielding garment 100. As a result, the holes 108 can provide general breathability to the radiation shielding garment 100, and the diameter of the holes 108 can be larger than 260 micrometers, as long as radiation shielding is maintained at the level desired.

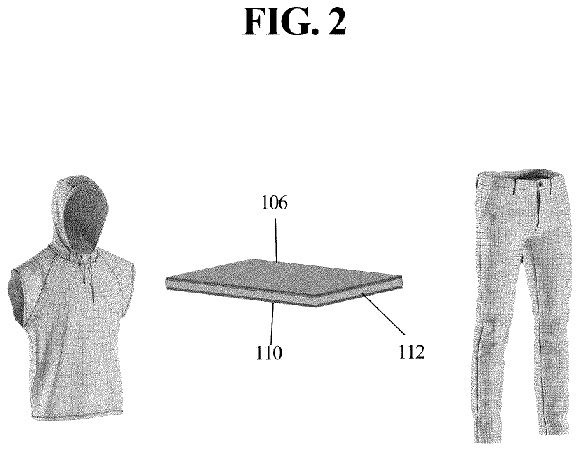

FIG. 2 illustrates another embodiment of the invention. A first radiation shielding outer layer 114 and second radiation shielding outer 116 layer may be positioned on opposite sides of a non-shielding inner layer 118. For example, the first and second radiation shielding layers of this embodiment may be similarly positioned as the first and second outer layers of FIG. 1. In addition, the non-shielding inner layer may be similarly positioned as the inner fabric layer 112 of FIG. 1. Similarly, the first and second radiation shielding outer layers can be composed of antimony (or a lead equivalent) with cotton and/or nylon, or water-resistant materials. The non-shielding inner layer 118 may be composed of soft materials including cotton or fleece.

It is noted that the present radiation shielding garment 100 is not limited in embodiment to a vest, rather. A vest is used as an example. The radiation shielding garment may encompass a range of garments, including jackets, vests, hats, and pants. In addition, the radiation shielding garments may be designed to mimic the appearance of traditional airline uniforms for seamless integration into the airline's dress code. In accordance with an alternative embodiment of the invention, the garments may be designed with removable linings, allowing crew members to adjust the level of protection and insulation according to their needs and flight conditions. Strategic placement of antimony-infused panels in areas most susceptible to radiation exposure, such as the torso and head, maximizes protection while minimizing additional weight.

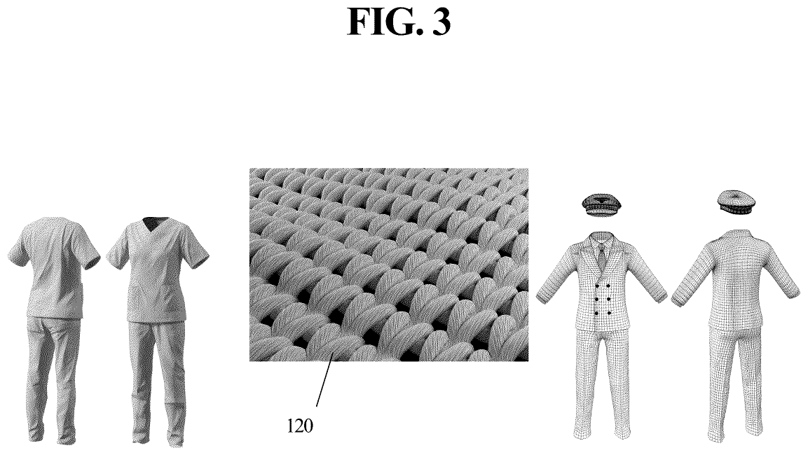

FIG. 3 illustrates another embodiment of the present invention where the radiation shielding garment 100 is created from an antimony (or lead equivalent) spun fabric 120 mixed with polyester and/or nylon and/or cotton or another material that provides comfort. Layers as in the first and second embodiments, are not necessary. Instead, the layers are replaced by spun fabric 120 created from radiation shielding antimony. Of course, to increase radiation shielding capability, one or more radiation shielding layer, such as those described as being in FIG. 1 and FIG. 2, may be used.

A process for creating the radiation shielding garment may include the following steps.

### Material Preparation

Antimony material, and/or bismuth or a lead equivalent in radiation shielding properties, is obtained in sheet or powdered form suitable for layering within fabric. Breathable cotton fabric sheets are prepared, ensuring that they are clean, free from contaminants, and appropriate for prolonged skin contact. As previously mentioned, another material may be used instead of cotton.

### Fabrication of the Inner Core

The radiation-shielding core is created by uniformly dispersing or layering antimony material to form a thin, flexible sheet. As is known by those having ordinary skill in the art, uniform dispersion does not mean that every particle of antimony material is located exactly the same distance form each other. Meaning is known in the art. Small, evenly spaced perforations (approximately 260 micrometers in diameter) are introduced across the antimony core to facilitate airflow and breathability without compromising radiation protection.

### Layering and Bonding

The antimony core layer is positioned centrally between two sheets of breathable cotton fabric. The layers are precisely aligned, ensuring even coverage and no wrinkles or folds that might compromise protective performance. The cotton and antimony layers are bonded securely together through stitching or ultrasonic welding techniques, ensuring durability, flexibility, and comfort for the wearer.

### Garment Assembly

The bonded protective material is cut into panels shaped according to the garment patterns designed for a vest suitable for general travelers and flight crews. The garment is assembled by sewing together the protective panels, incorporating zippers or closures at the front to facilitate easy wearing and removal. Ensuring that the seams are secure, reinforced, and designed to withstand regular use without separation or material fatigue is then done.

### Quality Control and Testing

Completed garments are inspected for integrity, including checks for uniformity of the radiation-shielding layer and structural durability. Radiation attenuation testing is performed to verify that the finished vest meets the desired protection standards against cosmic radiation.

### Final Preparation

The finished garments are cleaned and sterilized according to industry standards for apparel intended for frequent and prolonged wear. The finished garments are then packaged in protective packaging that clearly indicates the nature and intended use of the product, including labeling related to care, maintenance, and radiation protection capabilities.

It is noted that the configurations of FIGS. 1-3 are provided as examples and not intended to be definitive representations of a number of layers, dimensions of layers, or types of layers. The main component is that radiation shielding is being provided in clothing garments. Antimony particles and/or spun fabric can be mixed with water-resistant materials that commonly make up a raincoat, and the inner layer of the garment is comprised of fleece for comfort. This clothing line may include, but is not limited to pants, vests, hats, and jackets, which cover every vital and/or radiosensitive organ, significantly reducing the rate of radiation exposure to the individual wearing the apparel.

The use of antimony in combination with lightweight raincoat materials represents a significant innovation in the field of radiation-protective clothing, offering a practical balance between protection, comfort, and utility. The development of the present specialized process to embed antimony particles into fabric fibers without compromising the material's integrity or comfort is a key technical achievement. The design may incorporate modern tailoring techniques to ensure that the garments are not only protective but also aesthetically pleasing and comfortable for all-day wear.

In practical application, the present radiation shielding garment may be designed for airline pilots and flight attendants, where the clothing line offers a practical and efficient solution to reduce the health risks associated with cosmic radiation exposure. In addition, the technology and design principles can be adapted for use in other industries and applications where radiation protection is required, without sacrificing comfort or mobility.

The present invention can also be highly beneficial for healthcare workers who are exposed to high levels of radiation, such as radiologists, nurses, surgeons, nuclear medicine technicians, and interventional radiology staff. Healthcare workers face different types and levels of radiation exposure depending on their specific duties. The present invention can be tailored to offer variable levels of protection by adjusting the concentration and distribution of antimony (or lead equivalent) within the fabric, providing targeted protection for high-exposure areas. Higher concentration areas of the garment relate to higher radiation shielding ability.

What is claimed is:

1. A radiation protective garment, comprising:
a first fabric outer layer;
at least one radiation shielding layer configured to be comprised of an antimony-infused water-resistant material,
wherein the at least one radiation shielding layer has a plurality of holes; and
a second fabric outer layer.

2. The radiation protective garment of claim 1, wherein the water-resistant material is comprised of material including polyester, polyurethane, and Gore-Tex.

3. The radiation protective garment of claim 1, wherein the at least one radiation shielding layer is configured to be comprised of a lead equivalent-infused water-resistant material.

4. The radiation protective garment of claim 1, wherein the first fabric outer layer is configured to be comprised of materials including cotton, and nylon.

5. The radiation protective garment of claim 1, wherein the second fabric outer layer is configured to be comprised of soft materials including cotton, and fleece.

6. The radiation protective garment of claim 1, wherein if there are more than one radiation shielding layers, an inner fabric layer made of cotton separates the radiation shielding layers.

7. The radiation protective garment of claim 1, wherein the plurality of holes in the at least one radiation shielding layer have a diameter of 260 micrometers.

8. The radiation protective garment of claim 1, wherein if there are more than one radiation shielding layers, the plurality of holes in the at least one radiation shielding layers do not align when the radiation protective garment is worn.

9. A radiation protective garment, comprising:
a spun fabric; and
antimony particles evenly dispersed throughout the spun fabric.

10. The radiation protective garment of claim 8, wherein the spun fabric is comprised of materials including polyester, nylon, and/or cotton.

11. A method of integrating antimony particles evenly throughout raincoat fabrics comprising the steps of:
dispersing antimony particles evenly throughout the raincoat fabric,
wherein the dispersing includes blending 35% antimony or a lead equivalent, 25% polyester, 15% nylon, 15% polyethylene, and 10% elastane.
